(19) United States
(12) Patent Application Publication
(10) Pub. No.: US 2022/0229611 A1
(43) Pub. Date: Jul. 21, 2022

(54) PRINTING APPARATUS FACILITATING SECURE COMMUNICATIONS

(71) Applicant: Hewlett-Packard Development Company, L.P., Spring, TX (US)

(72) Inventors: James Shedden, Vancouver, WA (US); Tam Pham, Vancouver, WA (US)

(73) Assignee: Hewlett-Packard Development Company, L.P., Spring, TX (US)

(21) Appl. No.: 17/615,223

(22) PCT Filed: Sep. 20, 2019
(86) PCT No.: PCT/US2019/052056

§ 371 Date: Nov. 30, 2021

(51) Int. Cl. G06F 3/12; G06F 21/60; H04L 9/40

(52) U.S. Cl. CPC G06F 3/1222; G06F 3/1238; H04L 63/0442; G06F 21/608; G06F 3/1236

(57) ABSTRACT

A printing apparatus is disclosed including indicia displayed thereon in a matter that can be scanned by a client device. The indicia can include information to permit the client device to scan the indicia. Based on information obtained from the indicia, the client device can engage in encrypted or non-encrypted communication with the printing apparatus. The printing apparatus can further include a circuit to receive a client encrypted message from the client device. The client encrypted message can be generated by the client device using information extracted by the client device from the indicia. Responsive to receipt of the client encrypted message, the circuit can further decrypt the client encrypted message.

### BACKGROUND

Printing devices are typically provided with a variety of different ways to interface with the printing device. The present disclosure improves on the state of the art, as set forth herein.

### BRIEF DESCRIPTION OF FIGURES

Various examples may be more completely understood in consideration of the following detailed description in connection with the accompanying drawings, in which:

FIG. 1 is a diagram illustrating an example of a system including a printing apparatus and a client device in accordance with the present disclosure;

FIG. 2 is a diagram illustrating an example of a method of operating a printing apparatus using a client device in accordance with the present disclosure; and

FIG. 3 is a diagram illustrating a computer readable medium in accordance with the present disclosure.

While various examples discussed herein are amenable to modifications and alternative forms, aspects thereof have been shown by way of example in the drawings and will be described in detail. It should be understood, however, that the intention is not to limit the disclosure to the particular examples described. On the contrary, the intention is to cover all modifications, equivalents, and alternatives falling within the scope of the disclosure including aspects defined in the claims. In addition, the term “example” as used throughout this application is by way of illustration, and not limitation.

### DETAILED DESCRIPTION

The present disclosure relates to facilitating secure communication between a client device, and a second device, such as a printing device. Without secure communication between a client device, such as a mobile computing device, and a second device, such as a printer, it is possible for communications to be intercepted by a third party. The present disclosure provides methods, devices and non-transient media including machine readable instructions that, when executed by a circuit, permit secured communications in such a setting.

Thus, in some implementations, the disclosure includes a device, such as a printing apparatus. The printing apparatus can include indicia displayed on the printing device in a matter that viewable by a client device, such as a mobile electronic device. The indicia can include information to permit the client device to scan the indicia. Based on information obtained from the indicia, the client device can engage in encrypted or non-encrypted communication with the printing apparatus. The printing apparatus can further include a circuit to receive a client encrypted message from the client device. The client encrypted message can be generated by the client device using information extracted by the client device from the indicia. Responsive to receipt of the client encrypted message, the circuit can further decrypt the client encrypted message.

In some implementations, the disclosure includes a client device. The client device includes a client circuit to communicate with a printing apparatus. The client circuit can scan indicia displayed on the printing apparatus. The indicia include information to permit the client device to generate an encrypted communication readable by the printing apparatus. The client circuit can further generate a client encrypted message using the information from the indicia. The client circuit can further send the client encrypted message to the printing apparatus.

The disclosure further includes implementations of methods of operating a device, such as a printing apparatus. The method can include receiving a client encrypted message from a client device using a printing apparatus. The client encrypted message can be generated using information extracted by the client device using indicia disposed on the printing apparatus. Responsive to receipt of the client encrypted message from the client device, the printing apparatus can decrypt the client encrypted message.

The disclosure also includes implementations of a non-transitory machine readable medium storing instructions executable by a processor circuit to control a printing apparatus as described herein, the printing apparatus including a circuit to receive a client encrypted message from a client device, wherein the instructions, when executed by said circuit, cause the circuit to receive a client encrypted message from a client device including information relating to indicia detected by the client device on the printing apparatus. The instructions can further cause the circuit to decrypt the client encrypted message.

In some implementations, the present disclosure describes a method to provide a setup client/mobile device with a secure public key and a unique SSID to devices, methods and machine readable programs to permit communication, such as encrypted communication, between a client device and a target printer so as to avoid or greatly reduce the chance of a third party intercepting and reading a communication between the client device and the target printer, which is sometimes referred to as a “man-in-the-middle attack”. The disclosed embodiments also help prevent a client device from connecting to an incorrect printer. In some implementations, the printer can have a private key embedded in the firmware of the printer, and a public key encoded in a QR code that can be, for example, imprinted on a sticker on the outside of the target printer along with a unique setup SSID. During a setup process to connect a client device to the printer, the client device can capture the QR code on the printer as part of setting up communication between the client device and the printer. The client can derive a public key of the printer and/or can also derive a correct Wi-Fi or Bluetooth Low Energy (“BLE”) communication information for the printer. The client device can also have its own public key/private key pair for communication. The client device can send a message to the printer that is encrypted with the printer's public key. The message can include the device's public key. On receiving the message, the printer can decrypt the message using the printer's private key located in secure firmware disposed in a memory circuit on the printer. The printer can then encrypt any messages it wishes to send to the client device using the target client's public key. Assuming that the client device's private key is properly secured, only the client device will be able to decrypt (and read) the messages from the printer. Any messages that the client device sends to the target printer can correspondingly be encrypted with the target printer's public key.

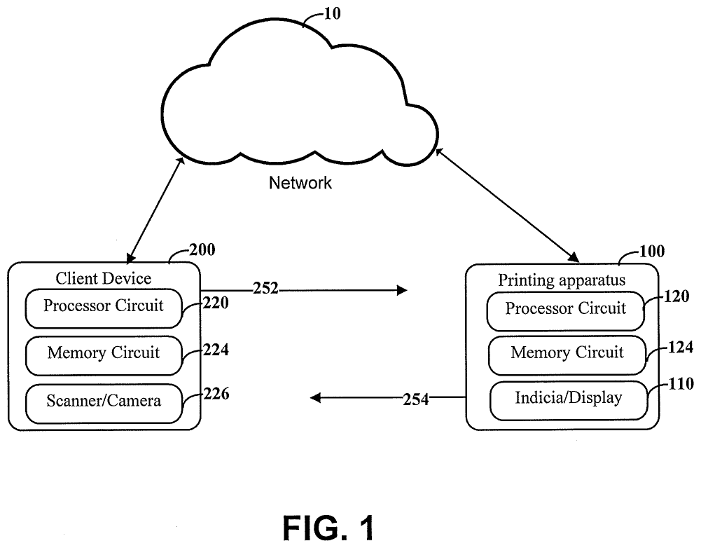

Turning now to the figures, FIG. 1 is a diagram illustrating an example of a client device 200 interacting with a printing device 100 either directly, or through a computer network 10, in accordance with the present disclosure. As illustrated in FIG. 1, the printing device 100 can include indicia 110 displayed on it in a location that is viewable by a client device. The indicia 110 should include information to permit a client device 200 to scan the indicia 110, and in turn to permit communication, including encrypted or non-encrypted communication, between the client device 200 and the printing apparatus 100. The printing apparatus 100 further includes a processor circuit 120 to receive and process a client encrypted message 252 from the client device 200, discussed further below, wherein the client encrypted message is generated on the client 200 by way of circuit 220. Printing apparatus further includes a memory circuit 124 coupled to the processor circuit 120 to store machine readable instructions. The client encrypted message 252 can be generated using information extracted by the client device 200 using the indicia 110. Responsive to receipt of the client encrypted message 252, the circuit 120 can decrypt the client encrypted message.

While a printing apparatus 100 is depicted as a target device for being coupled to a client device 200, other devices can be coupled to a client device 200 in a similar manner. For example, rather than a printing apparatus 100, the client device can use the same or a similar methodology to couple with other devices configured for electronic communication. For example, rather than a printer, the target device can be an automobile, wherein a user scans indicia located on the vehicle (e.g., inside the door), and then couple to an onboard computer in the vehicle to perform a diagnostic operation, a repair operation, to disable the vehicle, or to turn on and drive the vehicle. By way of further example, the target device can be a wireless speaker, electronic door lock, or other device. The same or a similar methodology as set forth herein can be used to couple any device pair that can use secure communication.

The indicia 110 can take on a variety of different forms. For example, the indicia can include a QR code disposed on the printing apparatus 100 in a location that can be scanned by the client device 200. By way of further example, the indicia can include a printer serial number or other identification number (that may also be unique) that a user can scan, for example, using client device 200. The serial number or other identification number (such as a SSID or other number) can be provided on an identification plate or sticker on the printer and can include the serial number or other identification number using an alphanumeric format, a bar code or other format. The indicia 110 can in some implementations use a stock keeping (“SKU”) number, or a RFID tag or NFC tag. In further implementations, indicia can include the shape of the printer or other target device or the shape of a part of the printer or other target device. The indicia can be formed into a surface of the printing apparatus 100 in a location that can be scanned by the client device 200.

If desired, the indicia can be displayed on a screen 160 of the printing apparatus (FIG. 1) that is scannable by the client device 200. The indicia can be updated periodically to assist with security, for example, and the client device 200 can scan the indicia 110 as set forth herein and extract SSID or other network identification information for a network that is connected to the printing apparatus to permit the client device to communicate with the printing apparatus, or a public encryption key for the printing apparatus 100 as desired.

The client device 200 can be any electronic device that is configured to communicate with printer 100 (or other target apparatus, as described above). For example, the client device can be a smart phone, a desktop computer terminal, a scanning device configured to communicate with a computing device, a tablet computer, a laptop computer, a digital transmitter, a RFID reader, a NFC reader, and the like. For example, as depicted in FIG. 1, client device 200 includes a processor circuit 220 coupled to a memory circuit 224 as well as a scanner or camera circuit 226 to scan the indicia 110.

While client device 200 can generate and send a client message or client encrypted message 252 directly to printing apparatus and printing apparatus 100 can generate and send a printer message or printer encrypted message to client device 200, the two devices 100, 200 may communicate indirectly through a computer network 10 that can be a LAN or other network, such as the world wide web.

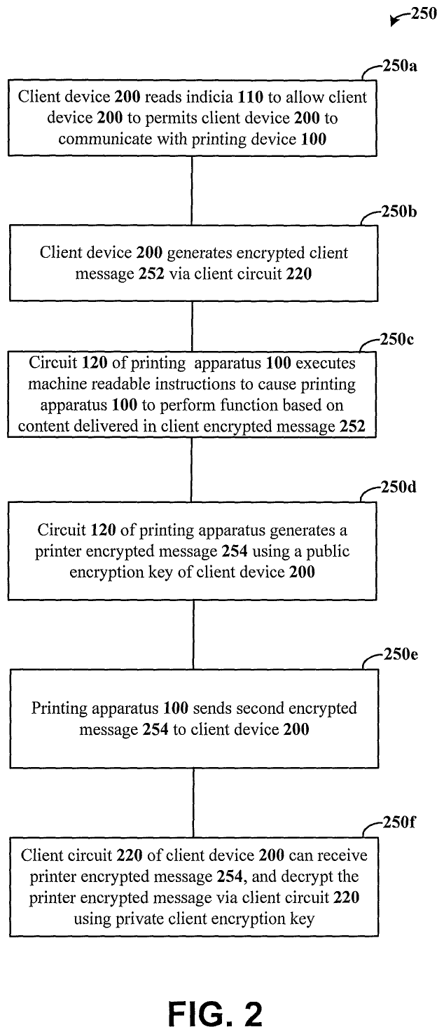

FIG. 2 illustrates a flow chart of an illustrative method 250 in accordance with the present disclosure for setting up a printing device 100 to communicate with a client device 200. In step 250a, client device 200 reads indicia 110, such as a QR code (or other indicia) to extract information from the indicia 110 to allow or cause the client device 200 to acquire information that in turn permits or causes client device 200 to communicate with the printing device 100. In some implementations, the indicia can include, for example, a SSID of the printer, and a public key corresponding to a private key embedded in the firmware of the printer among other things. If desired, the indicia can include information that permits the client device 200 to query a webpage for additional information to permit the client device to communicate with the printing device 100. For example, the indicia could include a SKU or serial number of the printer, such that when the client device 200 scans the indicia, a circuit within the client device parses information in the indicia and extracts a URL to a webpage on the Internet. The client device 200 can then query the webpage at the URL and obtain, for example, the public encryption key and/or SSID for the printing device 100. Moreover, the indicia can include a code that the client device needs to use to populate a field in the webpage at the URL in order to obtain the public encryption key and/or SSID.

In step 250b, the client device generates an encrypted client message 252 via client circuit 220. The encrypted client message 252 can include, for example, the public encryption ID, SSID, and other information, as desired, that can be parsed by the circuit 120 of the printing device 100, and send it to the printing apparatus 100. The client encrypted message can further include content to permit the printing apparatus to send an encrypted message to the client device 200. For example, the content can include a public encryption key of the client device 200 that corresponds to a private encryption key disposed in machine readable instructions disposed on the client device.

The client encrypted message 252 can further include other information, such as computer readable instructions to obtain desired information from the printing apparatus 100, such as status information of the printing apparatus. The status information can include, for example, instructions to query the printing apparatus 100 to determine if the printing apparatus 100 is online, whether the printing apparatus 100 is functioning properly, whether the printing apparatus 100 is in need of toner, ink, powder, a filament, or other printing material, whether any tray of the printing apparatus 100 is in need of paper or other printing media, how many print jobs are pending on the printing apparatus 100, and the like. Moreover, the encrypted client message 252 can further include a print file or other file from which the printer can print a document or perform another function. The circuit 120 of the printing device 100 parses the incoming message 252, and decrypts it, for example, using a private encryption key that corresponds to the public encryption key. The message from the client to the printer need not be encrypted. The disclosure contemplates implementations wherein one or more communications between the printing apparatus 100 and the client device are not encrypted.

In further accordance with the disclosure, at step 250c, the circuit 120 of the printing device 100 can execute machine readable instructions to cause the printing apparatus to perform a function based on the content delivered in the client encrypted message 252. For example, the circuit 120 of the printing apparatus can print information included in the client encrypted message, or may query status information concerning the printing apparatus as set forth above.

At step 250d, the circuit 120 of the printing apparatus can generate a printer encrypted message 254 using a public encryption key of the client device 200, for example, wherein information relating to the public encryption key of the client device 200 is included in the client encrypted message 252. At step 250e, the printing apparatus 100 can send the second encrypted message to the client device 200.

At step 250f, the client circuit 220 of the client device can receive the printer encrypted message 254, and decrypt the printer encrypted message via client circuit 220 using the private client encryption key disposed, for example, within firmware on the client device 200. The client device 200 can then execute a function based on the content of the printer encrypted message. Thus, the machine readable instructions disposed on the client device 200 can include a client public key and corresponding private key to permit encrypted communication between the printing apparatus 100 and the client device 200, and the client encrypted message 252 can include information relating to the client public key. These techniques can be used to relay any desired information between the client device 200 and the printing apparatus 100. As referenced herein above, these techniques can also be applied to other target devices and to other types of client devices to facilitate desired communications.

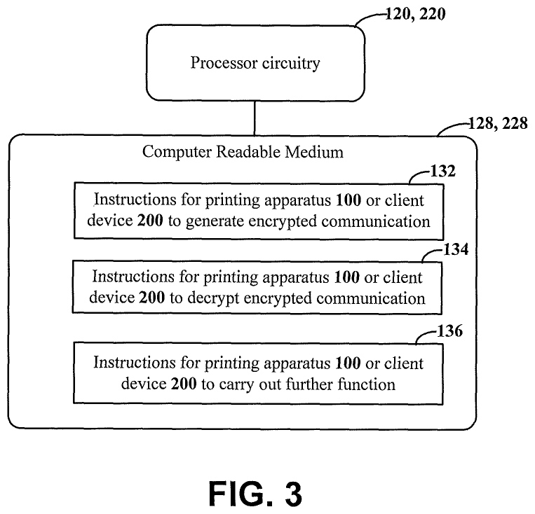

FIG. 3 is a schematic of a non-transient computer readable medium 128, 228 including machine readable instructions that can be read by processor circuits 120, 220 of printing apparatus 100 and client device 200. As an illustration, such machine readable instructions can include instructions 132 for the printing apparatus 100 or client device 200 to generate an encrypted communication. The instructions can include instructions 134 for the printing apparatus 100 or client device 200 to decrypt an encrypted communication, as well as instructions 136 for the printing apparatus 100 or client device 200 to carry out a further function, as set forth elsewhere herein. The computer readable medium 128, 228 can be any suitable non-transient computer readable medium.

The circuit executing the machine readable instructions relating to the above described method(s) and devices can be a programmed processor or a specialized processor. As such, the processor circuitry described herein, including associated data structures, can be stored on a tangible or physical (broadly non-transitory) computer-readable storage device or medium, such as volatile memory, non-volatile memory, ROM memory, RAM memory, magnetic or optical drive, device or diskette and the like. More specifically, the computer-readable storage device may include any physical devices that provide the ability to store information such as data and/or instructions to be accessed by a processor or a computing device such as a computer or an application server.

Terms to exemplify orientation, such as upper/lower, left/right, top/bottom and above/below, may be used herein to refer to relative positions of elements as shown in the figures. It should be understood that the terminology is used for notational convenience and that in actual use the disclosed structures may be oriented different from the orientation shown in the figures. Thus, the terms should not be construed in a limiting manner.

The skilled artisan would recognize that various terminology as used in the Specification (including claims) connote a plain meaning in the art unless otherwise indicated. As examples, the specification describes and/or illustrates aspects useful for implementing the claimed disclosure by way of various structures, such as circuits or circuitry, as may be recognized in the figures or the related discussion as depicted by or using terms such as device, system, processing circuitry, and/or other examples.

Certain of these aspects may also be used in combination to exemplify how operational aspects have been designed, arranged. Whether alone or in combination with other such blocks (or circuitry including discrete circuit elements such as transistors, resistors etc.), these above-characterized aspects may be implemented in the form of circuits configured/coded by fixed design and/or by (re)configurable circuitry (such as, CPUs/logic arrays/controllers) and/or circuit elements to this end of the corresponding structure carrying out such operational aspects. In certain examples, such a programmable circuit refers to or includes a computer circuit, including memory circuitry for storing and accessing a set of program code to be accessed/executed as instructions and/or (re)configuration data to perform the related operation, as may be needed. Depending on the data-processing application, such instructions (and/or configuration data) can be configured for implementation in logic circuitry, with the instructions (via fixed circuitry, limited group of configuration code, or instructions characterized by way of object code and/or computer executable instructions) as may be stored in and accessible from a memory (circuit).

Based upon the above discussion and illustrations, those skilled in the art will readily recognize that various modifications and changes may be made to the various examples without strictly following the exemplified examples and applications illustrated and described herein. For example, methods as exemplified in the Figures may involve elements carried out in various orders, with aspects of the examples herein retained, or may involve fewer or more elements. Such modifications do not depart from the scope of various aspects of the disclosure, including aspects set forth in the claims.

What is claimed is:

1. A printing apparatus comprising:
indicia displayed on the printing device viewable by a client device, the indicia including information to permit the client device to scan the indicia to permit encrypted communication between the client device and the printing apparatus;
a circuit to:
receive a client encrypted message from the client device, the client encrypted message being generated using information extracted by the client device using the indicia;
responsive to receipt of the client encrypted message, decrypt the client encrypted message.

2. The printing apparatus of claim 1, wherein the indicia includes a QR code disposed on the printing apparatus in a location that can be scanned by the client device.

3. The printing apparatus of claim 1, wherein the circuit is further to execute machine readable instructions to cause the printer to perform a function based on the content delivered in the client encrypted message.

4. The printing apparatus of claim 1, wherein the indicia includes a public encryption key that corresponds to a private encryption key embedded in machine readable instructions disposed in a memory circuit of the printing apparatus.

5. The printing apparatus of claim 4, wherein the client encrypted message includes information relating to the public encryption key of the printing device, and further wherein the circuit is to execute machine readable instructions to decrypt the client encrypted message using the private encryption key.

6. The printing apparatus of claim 5, wherein the circuit is further to:
generate a printer encrypted message using a public encryption key of the client device, wherein information relating to the public encryption key of the client device is included in the client encrypted message; and
send the second encrypted message to the client device.

7. The printing apparatus of claim 1, wherein the indicia is formed into a surface of the printing device in a location that can be scanned by the client device.

8. The printing apparatus of claim 1, wherein the indicia is displayed on a screen of the printing device that is scannable by the client device.

9. The printing apparatus of claim 3, wherein the indicia further includes network identification information for a network that is connected to the printing apparatus to permit the client device to communicate with the printing apparatus.

10. A client device including a circuit to communicate with a printing apparatus, including a client circuit that is to:
scan indicia displayed on the printing apparatus, the indicia including information to permit the client device to generate an encrypted communication readable by the printing apparatus;
generate a client encrypted message using the information from the indicia; and
send the client encrypted message to the printing apparatus.

11. The client device of claim 10, wherein machine readable instructions disposed on the client device include a client public key and corresponding private key to permit encrypted communication with the client device, and further wherein the client encrypted message includes information relating to the client public key.

12. The client device of claim 11, wherein the client circuit is further to:
receive a printer encrypted message received by the client device from the printing apparatus, the printer encrypted message including information relating to the client public key;
decrypt the printer encrypted message using the information from the indicia; and
execute a function based on the content of the printer encrypted message.

13. A method of operating a printing apparatus comprising:
receive a client encrypted message from a client device using a printing apparatus, the client encrypted message generated using information extracted by the client device using indicia disposed on the printing apparatus; and
responsive to receipt of the client encrypted message from the client device, decrypting the client encrypted message using the printing apparatus.

14. The method of claim 13, wherein the indicia includes a public encryption key that corresponds to a private encryption key embedded in machine readable instructions disposed in a memory circuit in the printing apparatus.

15. The method of claim 13, wherein the client encrypted message includes information relating to a client public key disposed on the client device.
